(19) United States
(12) Patent Application Publication
(10) Pub. No.: US 2008/0176179 A1
(43) Pub. Date: Jul. 24, 2008

(54) Dental apparatus

(76) Inventor: Paula Coffee, Greenwood Village, CO (US)

Correspondence Address: JAMES RAY & ASSOCIATES, 2640 PITCAIRN ROAD, MONROEVILLE, PA, 15146, US

(21) Appl. No.: 12/009,291

(22) Filed: Jan. 17, 2008

Related U.S. Application Data
(60) Provisional application No. 60/881,306, filed on Jan. 19, 2007.

(51) Int. Cl. A61C 7/10

(52) U.S. Cl. 433/7

(57) ABSTRACT

A dental apparatus is provided. Such dental apparatus includes two dental band members operably connected together at a predetermined location thereon for placement between two adjacent teeth of a patient. Such two dental band members are manufactured from a first predetermined material and have a first predetermined size and a first predetermined shape. Such dental apparatus also includes a mechanism for at least one of separating such two adjacent teeth of such patient and engaging such patient's teeth such that each dental band member sits closely adjacent a respective tooth of such patient in a manner conducive to a dentistry procedure including at least restorative dentistry.

### CROSS REFERENCE TO RELATED APPLICATION

This patent application is related to and claims priority from U.S. Provisional Patent Application Ser. No. 60/881,306 filed Jan. 19, 2007.

### FIELD OF THE INVENTION

The present invention relates, in general, to dental equipment and, more particularly, this invention relates to dental bands for restorations.

### BACKGROUND OF THE INVENTION

Prior to the conception and development of the present invention, dental bands, as are generally well known in the prior art, have been used by dentists during the restoration process.

Specifically of interest to the present invention are the following: Rashid, U.S. Pat. No. 5,460,525, provides a dual dental matrix band retainer for use in dentistry comprising a first matrix band retainer which is connected to a second matrix band retainer. Each matrix band retainer is provided with a matrix band which is looped around a different posterior tooth in the same quadrant of a patient's mouth.

Zall, et al, provides a matrix band guide for use in simultaneously applying a matrix band to a plurality of teeth. The guide is a flexible elongated member having a plurality of slots. The elongated member is of sufficient length and of sufficient width to allow placement of the guide against the teeth and to guide the matrix band around the teeth. The slots are of a width, height and spacing sufficient to permit the looping of the matrix band through the slots to form a plurality of loops for binding engagement with the teeth. When the matrix band is drawn into binding engagement with the teeth, the elongated member and the matrix band substantially conform to the taper and curvature of the teeth.

### SUMMARY OF THE INVENTION

The present invention provides a dental apparatus. The dental apparatus includes two dental band members operably connected together at a predetermined location thereon for placement between two adjacent teeth of a patient. The two dental band members are manufactured from a first predetermined material and have a first predetermined size and a first predetermined shape. The dental apparatus further includes a means for at least one of separating such two adjacent teeth of such patient and engaging such patient's teeth such that each dental band member sits closely adjacent a respective tooth of such patient in a manner conducive to a dentistry procedure including at least restorative dentistry.

### OBJECTS OF THE INVENTION

It is, therefore, one of the primary objects of the present invention to provide a dental apparatus which can be easily placed between two adjacent prepped teeth and which can engage those two teeth such that both teeth can be subject to simultaneous restorative dentistry thereby reducing the steps necessary to complete multiple restorations.

Another object of the present invention is to provide a dental apparatus for use on two adjacent teeth needing dentistry procedures thereby increasing the convenience of both the dentist and the patient.

Still another object of the present invention is to provide a convenient and cost efficient means for providing more comfortable dentistry to patients, as well as reducing the amount of time spent in the chair, which is beneficial to both the patient and the dentist.

Yet another object of the present invention is to provide an easy to use tool to simplify the restoration process when multiple restorations are required on adjacent teeth.

Another object of the present invention is to provide a means to obtain a tighter contact between two adjacent teeth, eliminating the possibility of food impaction, which is not only annoying to the patient, but destructive to the teeth and the supporting periodontal tissues of the patient's mouth.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partial perspective view of a dental apparatus according to one embodiment of the invention in which the means for at least one of separating such two adjacent teeth of such patient and engaging such patient's teeth is a clamp with a handle.

FIG. 2 is a partial perspective view of a dental apparatus according to one embodiment of the invention; in this illustration decay has been removed from the patient's teeth leaving holes that will require fillings.

FIG. 3 is a partial perspective view of a dental apparatus according to one embodiment of the invention, in this illustration cavities in the patient's teeth have been replaced by fillings.

FIG. 4 is a partial perspective view of a dental apparatus according to one embodiment of the invention in which the two dental band members are manufactured from a first predetermined material having a memory and wherein the means for at least one of separating such two adjacent teeth of such patient and engaging such patient's teeth is pressure exerted by such dental band members once such dental apparatus is placed between such teeth of a patient.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

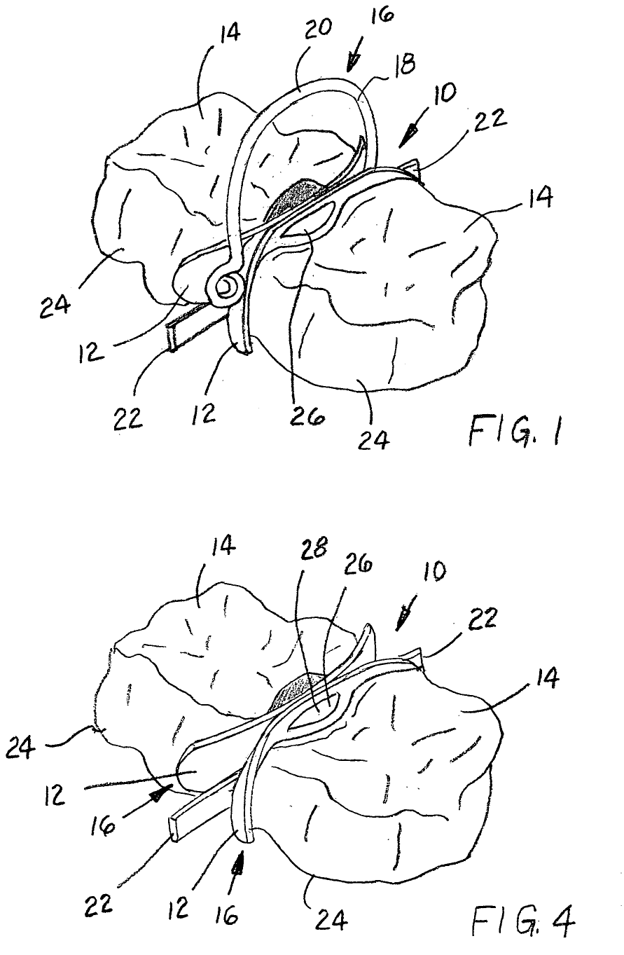

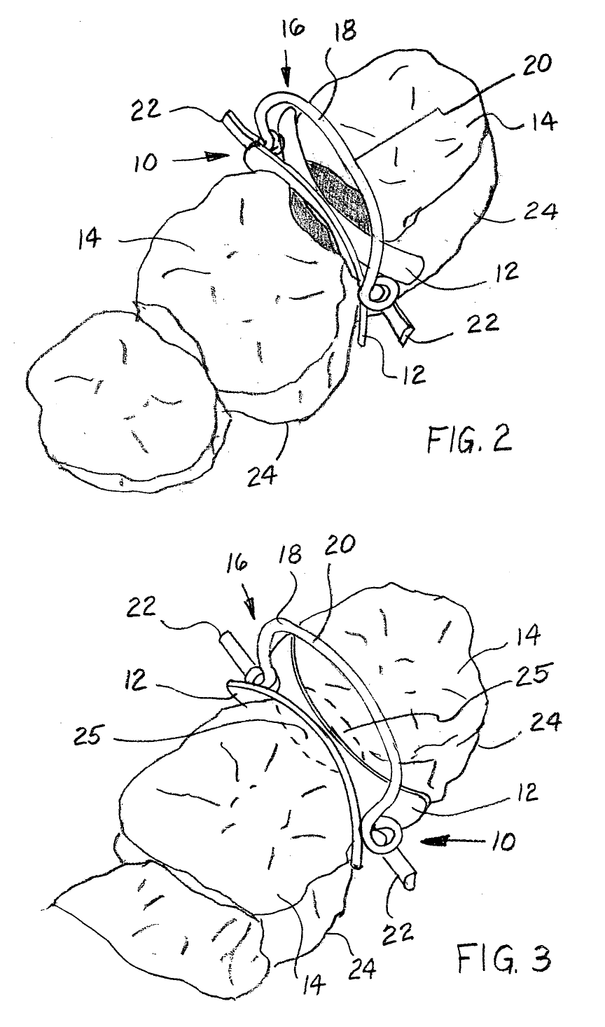

Reference is now made, more particularly, to FIGS. 1-4.

A dental apparatus, generally designated 10, is provided. Such dental apparatus 10 includes two dental band members 12 operably connected together at a predetermined location thereon for placement between two adjacent teeth 14 of a patient. Such two band members 12 may also be formed as a single piece.

The two dental band members 12 are manufactured from a first predetermined material and have a first predetermined size and a first predetermined shape. It is presently preferred that such first predetermined material is at least one of metal, plastic and a combination thereof. It is presently most preferred that such first predetermined material is metal.

It is further presently preferred that such dental band members 12 are connected together by at least one of gluing, fusing, and welding. It is also possible, however, that such dental band members are formed from in a single piece such that a connector substance is not needed.

It is presently preferred that such first predetermined size includes a plurality of sizes including both adult sizes and child sizes as well as a range of sizes within each of those groups.

Such dental apparatus 10 further includes a means, generally designated 16, for at least one of separating such two adjacent teeth 14 of such patient and engaging such patient's teeth 14 such that each of the two dental band members sits closely adjacent a respective tooth 14 of such patient in a manner conducive to a dentistry procedure including at least restorative dentistry.

It is presently preferred that such means 16 for at least one of separating such two adjacent teeth 14 of such patient and engaging such patient's teeth 14 is at least one clamp 18.

It is further presently preferred that such means 16 for at least one of separating such two adjacent teeth 14 of such patient and engaging such patient's teeth 14 further includes a handle member 20.

It is presently preferred that such dental apparatus 10 further includes at least one wedge device 22 manufactured from a second predetermined material and having a second predetermined size and a second predetermined shape for placement at a predetermined location between such adjacent teeth 14 of a patient for ensuring that a filling, generally designated 25, of each respective tooth is flush with at least one of a base of an interproximal box (not shown) and such tooth at a gumline 24. It is presently preferred that such second predetermined material is at least one of wood, plastic and rubber. It is presently most preferred that such second predetermined material is wood.

In the presently preferred embodiment of the invention, the two dental band members 12 further include a contact member 26 operably connected to the two dental band members 12 at a predetermined location thereon, such contact member 26 being manufactured from a third predetermined material and having a third predetermined size and a third predetermined shape.

It is presently preferred that such third predetermined material is at least one of mylar, plastic, and metal. It is presently most preferred that such third predetermined material is mylar. It is also presently preferred that the third predetermined shape is an oval 28.

As seen in FIG. 1, there is an oblong aperture cut out of the two dental band members 12 and filled with a thin strip of material to form the contact member 26. The contact member 26 is in a position on the two dental band members 12 to allow for a close approximation of two adjacent fillings 25 once restorative dentistry procedures have been completed on each tooth.

According to another embodiment of the invention such first predetermined material is at least one of a plastic and metal having a memory. It is presently most preferred that such first predetermined material is a metal having a memory. In this embodiment, it is presently preferred that the means 16 for at least one of separating such two adjacent teeth 14 of such patient and engaging such patient's teeth 14 is pressure exerted by such two dental band members 12 once such dental apparatus 10 is placed between such teeth 14 of a patient.

According to still another embodiment of the invention such first predetermined material is a formable metal. In this embodiment, the means 16 for at least one of separating such two adjacent teeth 14 of such patient and engaging such patient's teeth 14 is such formable metal molded to the respective teeth once such dental apparatus 10 is placed between such teeth 14 of a patient.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A dental apparatus comprising;
a. two dental band members operably connected together at a predetermined location thereon for placement between two adjacent teeth of a patient, said two dental band members being manufactured from a first predetermined material and having a first predetermined size and a first predetermined shape; and
b. a means for at least one of separating such two adjacent teeth of such patient and engaging such patient's teeth such that each of said two dental band members sits closely adjacent a respective tooth of such patient in a manner conducive to a dentistry procedure including at least restorative dentistry.

2. A dental apparatus according to claim 1 wherein said first predetermined material is at least one of metal, plastic and a combination thereof.

3. A dental apparatus according to claim 1 wherein said first predetermined material is metal.

4. A dental apparatus according to claim 1 wherein said dental band members are connected together by at least one of gluing, fusing, and welding.

5. A dental apparatus according to claim 1 wherein said dental apparatus further includes at least one wedge device manufactured from a second predetermined material and having a second predetermined size and a second predetermined shape for placement at a predetermine location between such adjacent teeth of such patient for ensuring that a filling of each respective tooth is flush with at least one of a base of an interproximal box and such tooth at a gumline.

6. A dental apparatus according to claim 5 wherein said second predetermined material is at least one of wood, plastic and rubber.

7. A dental apparatus according to claim 5 wherein said second predetermined material is wood.

8. A dental apparatus according to claim 1 wherein said means for at least one of separating such two adjacent teeth of such patient and engaging such patient's teeth is at least one clamp.

9. A dental apparatus according to claim 1 wherein said two dental band members further include a contact member operably connected to said two dental band members at a predetermined location thereon, said contact member being manufactured from a third predetermined material and having a third predetermined size and a third predetermined shape.

10. A dental apparatus according to claim 9 wherein said third predetermined material is at least one of mylar, plastic, and metal.

11. A dental apparatus according to claim 1 wherein said first predetermined size includes a plurality of sizes.

12. A dental apparatus according to claim 1 wherein said means for at least one of separating such two adjacent teeth of such patient and engaging such patient's teeth further includes a handle member.

13. A dental apparatus according to claim 1 wherein said first predetermined material is at least one of a plastic and a metal having a memory.

14. A dental apparatus according to claim 13 wherein said first predetermined material is a metal having a memory.

15. A dental apparatus according to claim 13 wherein said means for at least one of separating such two adjacent teeth of such patient and engaging such patient's teeth is pressure exerted by said two dental band members once said dental apparatus is placed between such teeth of such patient.

16. A dental apparatus according to claim 9 wherein said third predetermined shape is an oval.

17. A dental apparatus according to claim 1 wherein said means for at least one of separating such two adjacent teeth of such patient and engaging such patient's teeth is a formable metal.

18. A dental apparatus according to claim 1 wherein said band members are formed as a single piece.
